(19) United States
(12) Patent Application Publication
(10) Pub. No.: US 2024/0202556 A1
(43) Pub. Date: Jun. 20, 2024

(54) PRECOMPUTED EXPLANATION SCORES

(71) Applicant: International Business Machines Corporation, Armonk, NY (US)

(72) Inventors: Stefan A. G. Van Der Stockt, Austin, TX (US); ERIKA AGOSTINELLI, Bristol (GB); Edward James Biddle, Winchester (GB); Sourav Mazumder, Contra Costa, CA (US)

(21) Appl. No.: 18/067,852

(22) Filed: Dec. 19, 2022

(51) Int. Cl. G06N 5/045; G06N 5/022

(52) U.S. Cl. CPC G06N 5/045; G06N 5/022

(57) ABSTRACT

A method, system, and computer program product generate precomputed explanation scores in AI systems. The method includes obtaining a set of labeled transactions comprising input features and corresponding output labels generated by a machine learning (ML) model and generating an explainable artificial intelligence (XAI) module. The generating includes clustering the labeled transactions based on the input features, scoring homogeneity of the clustered transactions based on the corresponding output labels, and selecting at least one cluster from the clustered transactions based on the homogeneity scoring. The generating further includes obtaining, by an explainability model, explainability scores for transactions in the at least one cluster, generating a unified explainability score for the at least one cluster based on the explainability scores, and storing the unified explainability score in a set of precomputed explanations.

### BACKGROUND

The present disclosure relates to explainable artificial intelligence and, more specifically, to generating precomputed explanations that may be selected based on input features of transactions.

Artificial intelligence (AI) can be used in a variety of applications, such as generating decisions, predictions, classifications, etc. based on input data. For example, deep learning and other machine learning (ML) techniques may be trained on transactional data to generate these outputs in response to new database transactions. Monitoring of deployed ML models can be an important part of maintaining high quality results in these applications. Examples of this monitoring can include model performance and data monitoring, outlier and data drift detection using statistical techniques, and generating explanations of model predictions. For example, explanations may be generated by scoring the positive or negative influence each input variable has on a model's output.

### SUMMARY

Various embodiments are directed to a method that includes obtaining, by a processor communicatively coupled to a memory, a set of labeled transactions comprising input features and corresponding output labels generated by a machine learning (ML) model and generating, by the processor, an explainable artificial intelligence (XAI) module. The generating includes clustering the labeled transactions based on the input features, scoring homogeneity of the clustered transactions based on the corresponding output labels, and selecting at least one cluster from the clustered transactions based on the homogeneity scoring. The generating further includes obtaining, by an explainability model, explainability scores for transactions in the at least one cluster, generating a unified explainability score for the at least one cluster based on the explainability scores, and storing the unified explainability score in a set of precomputed explanations. In some embodiments, the method also includes receiving a live transaction from a user device. An explainability score may be selected for the live transaction from the set of precomputed explanations. The explainability score may be selected based on input features of the live transaction.

Further embodiments are directed to a system, which includes a memory and a processor communicatively coupled to the memory, wherein the processor is configured to perform the method. Additional embodiments are directed to a computer program product, which includes a computer readable storage medium having program instructions embodied therewith, the program instructions executable by a processor to cause a device to perform the method.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of typical embodiments and do not limit the disclosure.

FIG. 1 is a block diagram illustrating a computing environment, according to some embodiments.

FIG. 2 is a block diagram illustrating a transaction explainability environment, according to some embodiments.

FIG. 3 is a flowchart illustrating a process of generating unified explanation scores, according to some embodiments.

FIG. 4 is a dendrogram illustrating clustered transactions, according to some embodiments.

FIG. 5 is a flowchart illustrating a process of determining explainability of live transactions, according to some embodiments.

### DETAILED DESCRIPTION

Aspects of the present disclosure relate generally to explainable artificial intelligence and, more specifically, to generating precomputed explanations that may be selected based on input features of transactions. While the present disclosure is not necessarily limited to such applications, various aspects of the disclosure may be appreciated through a discussion of various examples using this context.

Use of artificial Intelligence (AI) to make predictions, analyze data, and carry out a variety of other tasks is becoming increasingly prominent in organizations. However, the decision-making processes of underlying machine learning (ML) models can be opaque, leading to potential uncertainty over the accuracy or quality of their output. Conventional techniques for understanding ML model behavior can use partial dependence plots, residual analysis machine learning models, generalized additive ML models, etc. Further, various frameworks have been developed that use one or more algorithms such as LIME (Local Interpretable Model-agnostic Explanations), Contrastive Explanations, SHAP (SHapely Additive explanations), etc., to generate explanations for ML model outputs.

However, integration of existing frameworks into operational applications can be impractical because of the time and resource requirements. Calculating explainability for any specific transaction can be a computationally intensive task and can require orders of magnitude of additional computing resources than running the model itself. For example, algorithms such as LIME can require thousands of extra-model evaluations to explain a single model transaction. This challenge can be magnified when moving from development to production systems, in which maintaining a real-time explanation requirement raises concerns around feasibility, cost, and latency. This may cause the load created by explainability requests to vastly exceed available computational resources.

Further, explainability models often rely on response functions being monotonically constrained by particular classifications that are made in order to explain model behavior. This can require classification boundaries that are uniform and symmetrical in order to correctly interpret the behavior of an ML model. This may limit the accuracy of models such as neural networks, which can have asymmetrical and non-uniform classification boundaries that may resemble a non-monotonic response function.

Some behavioral models for explainability, such as surrogate behavioral models, employ a simple model, such as a linear model, a decision tree, or a decision list data structure, that is trained from input/output pairs generated by the machine learning model itself. However, surrogate modeling can require large and complex calculations to prevent insufficient prediction accuracy incurred by using a simpler model. Decision trees and decision list data structures, for example, often become complex to the point where they sacrifice explanatory power. As a decision tree grows (e.g., adds more leaf nodes and decisions), it can become more complex, rendering it increasingly less useful as an explanation. Moreover, variables used in root or branch node splits in the decision tree are fixed, implying that their values are always the most relevant in providing an explanation for the machine learning model's classification output. However, this is not always the case and can make it difficult to accurately explain certain behaviors of the ML model that are prone to change over time.

Embodiments of the present disclosure may overcome these and other challenges by providing precomputed explanations for ML model outputs rather than generating a new explanation for each output. For example, precomputed explanations may be shared by transactions with similar input space features. The precomputed explanations may be generated using an explainability model trained on historical transactions. In some embodiments, precomputed explanations may be generated based on the behavior of a prototype model with a representative subset of data points of an ML model. The subset of data points included in the prototype model may collectively mimic or capture the overall classification behavior of the ML model. Thus, the prototype model may be used to learn the machine learning model's behavior or performance.

When a new transaction is received, it may be determined based on the input space of the new transaction at run-time whether the new transaction can use a stored precomputed explanation. Leveraging precomputed explanations for new transactions may reduce the number of explanations that must be generated. This may allow explanations to be determined for outputs in real time, or close to real time, with a fraction of the computational resources needed for conventional explainability techniques.

The aforementioned advantages are example advantages and should not be construed as limiting. Embodiments of the present disclosure can contain all, some, or none of the aforementioned advantages while remaining within the spirit and scope of the present disclosure.

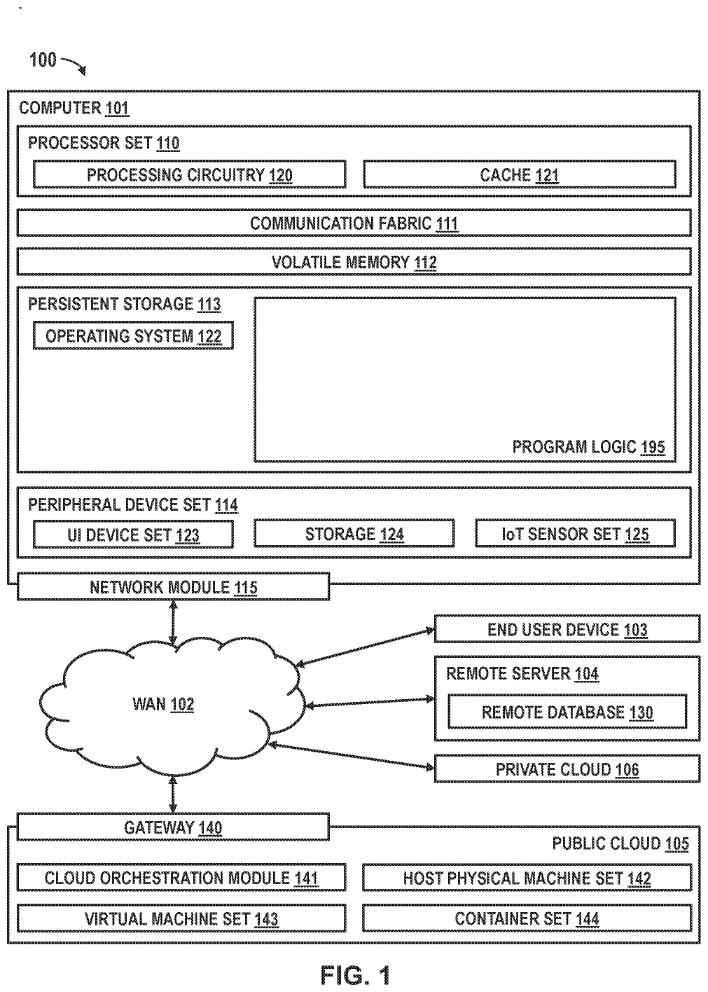

Turning now to the figures, FIG. 1 is a block diagram illustrating a computing environment 100, according to some embodiments of the present disclosure. Computing environment 100 contains an example of a program logic 195 for the execution of at least some of the computer code involved in performing the inventive methods, such as generating precomputed (unified) explanations for clustered transactions and/or finding precomputed explanations for new transactions based on input variables. In addition to block 195, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 195, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 195 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 195 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

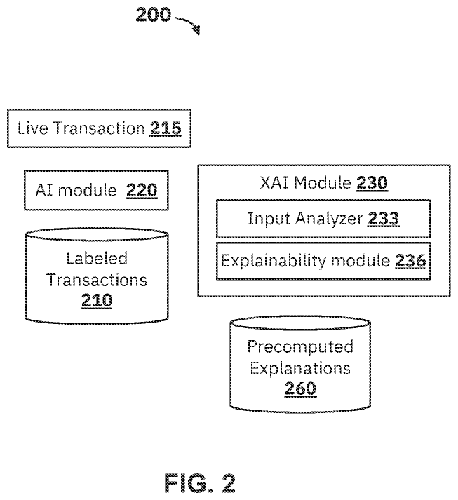

FIG. 2 is a block diagram illustrating a computing environment 200 for transaction explainability, according to some embodiments of the present disclosure. Computing environment 200 may implement program logic 195 (FIG. 1). Environment 200 may include a set of labeled transactions 210. Labeled transactions 210 may be completed transactions that are processed/stored by a data mart, data warehouse, etc. Labeled transactions 210 can include both input features and output labels. In some embodiments, labeled transactions 210 may be stored in a database that handles transactions implemented by a database management system (not shown). For example, labeled transactions 210 may be stored in an operational database, relational database, object database, distributed database, cloud database, unstructured database, etc. The database system may implement distributed transactions over multiple nodes (e.g., database(s), file systems, storage managers, messaging systems, etc.).

Environment 200 may also include at least one live transaction 215 (e.g., implemented by the database management system). Each transaction (e.g., labeled transactions 210 and/or live transaction 215) may represent a unit of work performed within the database management system against a database. For example, each transaction may represent a database query.

Environment 200 may also include an artificial intelligence (AI) module 220, which may “classify” training data against a target model (or the model's task) and uncover relationships between and among the classified training data. For example, AI module 220 may include clustering models and/or machine learning (ML) algorithms that may include neural networks, support vector machines (SVMs), logistic regression, decision trees, hidden Markov Models (HMMs), etc. In some embodiments, learning or training performed by AI module 220 may be supervised, unsupervised, or a hybrid that includes aspects of supervised and unsupervised learning.

Environment 200 may also include an explainable artificial intelligence (XAI) module 230, which can include an input analyzer 239 configured to evaluate input features of transactions 210 and 215. Input features of transactions 210 and 215 may be extracted and converted to vector representations by AI module 220. For example, input features may be represented by an input space vector I with n input fields/variables. AI module 220 may generate n output predictions, probabilities, decisions, etc. (“output labels”) corresponding to input features of transactions.

XAI module 230 may include an input analyzer 233. Input analyzer 233 may receive and evaluate input features of training data (e.g., labeled transactions 210) and data-under-analysis (e.g., live transactions 215). For example, where input transaction data includes natural language data, input analyzer 233 may use natural language processing (NPL) techniques to extract transaction features, transaction outcomes, etc. Input analyzer 233 may apply machine learning techniques to received training data (e.g., labeled transactions 210) in order to, over time, create/train/update one or more models that model the overall task and the sub-tasks that XAI module 230 is designed to complete. Input analyzer 233 may include at least one ML model/algorithm that can carry out techniques such as clustering, classifying, decision-making, predicting, etc.

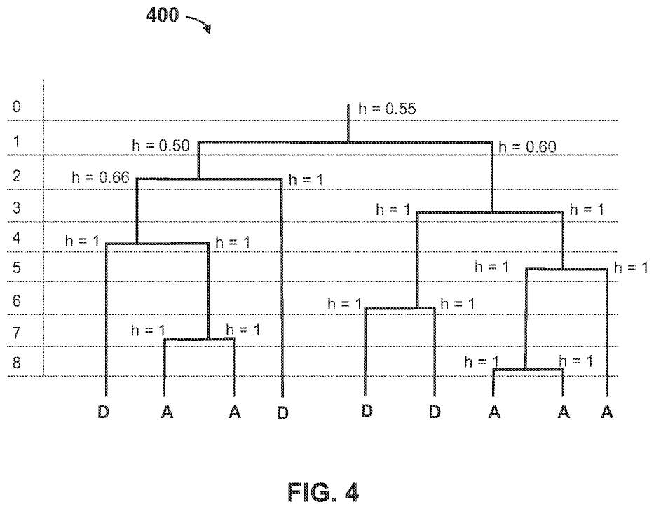

In some embodiments, input analyzer 233 clusters the input features of labeled transactions 210 using, e.g., a top-down approach such as divisive hierarchical clustering. The hierarchical clustering may generate at least one branch level of input space clusters with similar input features. For example, the input space of the labeled transactions 210 can begin in one cluster, which can then be divided recursively moving down the hierarchy. An example of this is illustrated in FIG. 4 and discussed in greater detail below.

Input analyzer 233 may determine whether two or more transactions in a given cluster have matching output labels. A cluster in which all transactions have matching labels is referred to herein as a “homogeneous cluster”, and a cluster containing at least two transactions with different output labels is referred to herein as a “non-homogeneous cluster”. In some embodiments, all non-homogenous clusters may be classified as heterogeneous (e.g., a threshold homogeneity score of h=1). Non-homogeneous clusters may be further divided into “quasi-homogeneous” and “heterogeneous” clusters. For example, clusters in which more than a threshold number of transactions have the same label may be classified as quasi-homogeneous, and clusters in which fewer than a threshold number of transactions have the same label may be classified as heterogeneous. These thresholds may be threshold homogeneity scores (e.g., for quasi-homogeneous clusters, 0.5<h<1).

Input analyzer 233 may also determine homogeneities of branch levels generated by hierarchical clustering of the input space. For example, the homogeneity scores of each input space cluster in a given branch level may be used to determine the branch level's homogeneity. This is discussed in greater detail with respect to FIG. 4.

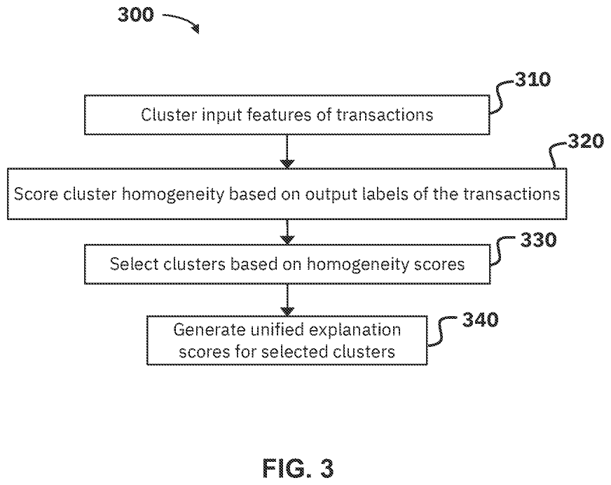

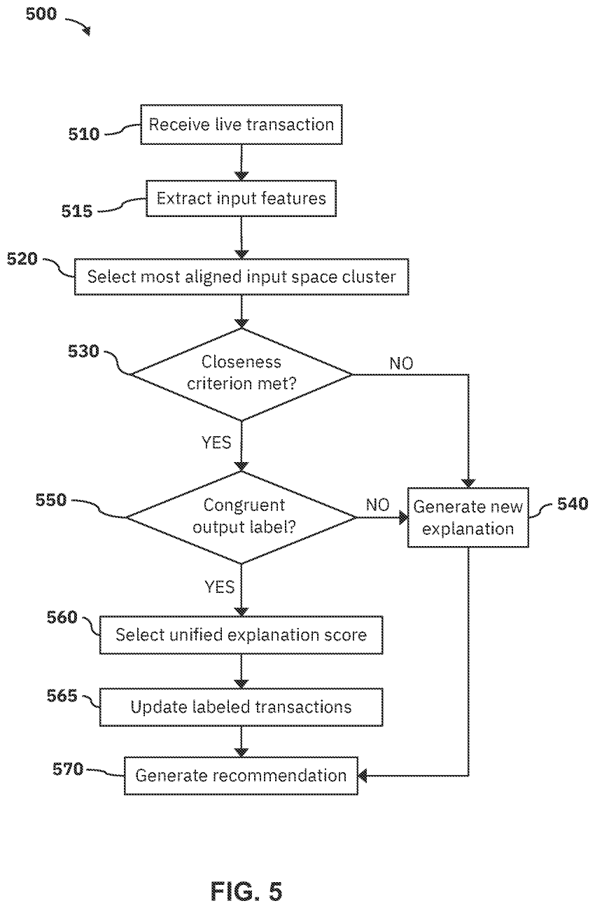

In some embodiments, XAI module 230 includes an explainability component 236, which may include an explainability model such as LIME, Contrastive Explanations, SHAP, etc., for calculating explanation scores for transactions 210 and/or 215. For a given transaction, an explanation score can indicate the degree of influence of an input variable on an output of the transaction. The explainability component 236 may also generate unified explanations for clustered transactions 210. This is discussed in greater detail with respect to FIG. 3. The transaction explanations and/or unified explanations may be stored in a set of precomputed explanations 260. In some embodiments, live transactions 215 may use an explanation score from precomputed explanations 260. This is discussed in greater detail with respect to FIG. 5.

FIG. 3 is a flowchart illustrating a process 300 of generating unified explanations (e.g., precomputed explanations 260), according to some embodiments. Process 300 may be performed by components of environment 200 and, for illustrative purposes, is discussed with reference to FIG. 2. Labeled transactions 210 may be used as training data by input analyzer 233 in process 300. In process 300, transactions may be clustered based on input features. This is illustrated at operation 310. In some embodiments, labeled transactions 210 include a set of queries (transactions) T=[T₁, . . . , T_{q}]. Each of the labeled transactions 210 may have input features represented by fields in an input space vector. In some embodiments, AI module 220 extracts these features and generates the input space vector representations.

In some embodiments, input analyzer 233 can use unsupervised machine learning techniques such as divisive hierarchical clustering to group transactions based on their input variables. For example, the hierarchical clustering may begin with one input space cluster containing all of the completed transactions. This cluster can be divided recursively at branch levels moving down the hierarchy. An example of this is illustrated in FIG. 4 (see below).

At operation 320, output labels of the clustered transactions can be used to score homogeneity of the clusters. Input analyzer 233 may score homogeneity of the input space clusters based on output labels of the labeled transactions 210. Homogeneous regions of the input space may be identified based on the homogeneity scores generated at operation 320. This is discussed in greater detail below.

FIG. 4 is a dendrogram 400 illustrating clustered transactions, according to some embodiments. The illustrated dendrogram 400 includes branch levels 0-8 of hierarchically clustered labeled transactions. The clusters may be generated from input vectors of labeled transactions 210 (e.g., at operation 310 of process 300). Each cluster is illustrated with a homogeneity score h, which may be generated by input analyzer 233 based on the output labels of clusters in the transactions (e.g., at operation 320 of process 300).

The output labels illustrated in FIG. 4 include transaction outcomes “approved” (A) or “denied” (D). Clusters that contain either all “approved” transactions or all “denied” transactions can have scores h=1 and clusters that contain at least one A transaction and at least one D transaction can have scores h<1.

The homogeneity scores may be determined by finding a “majority label” Lₘₐⱼ, which can be a label shared by the largest number of transactions in a given cluster Cᵢ. The homogeneity score h of the cluster Cᵢ may then be found using Equation 1:

$$h ( {C}_{i} ) = \frac{{T}_{maj}}{{T}_{tot}} \qquad Eq . 1$$

where Tₘₐⱼ is the quantity of transactions with the majority label in the cluster Cᵢ and Tₜₒₜ is the total number of transactions in the cluster Cᵢ.

TABLE 1

| Branch Level j | H(Bⱼ) |
|---|---|
| 0 | 0.55 |
| 1 | 0.55 |
| 2 | 0.75 |
| 3 | 0.92 |
| 4 | 1 |
| 5 | 1 |
| 6 | 1 |
| 7 | 1 |
| 8 | 1 |

A non-homogenous cluster may be classified as heterogeneous at if it has a homogeneity score below a threshold score. In some embodiments, the non-homogeneous clusters may be divided into heterogeneous clusters and quasi-homogenous clusters. For example, quasi-homogeneous clusters may be clusters in which a threshold quantity of the transactions have the same label (e.g., greater than 50% of transactions, or h=0.5). In some embodiments, this threshold can be adjusted.

Referring again to FIG. 3, process 300 may include selecting homogenous and/or quasi-homogeneous clusters based on the homogeneity scores. This is illustrated at operation 330. Selection of clusters based on homogeneity scores may also include determining branch homogeneity scores based on the cluster homogeneity scores. Any appropriate scoring technique may be used to obtain branch homogeneity scores based on the cluster homogeneities. In the example illustrated in FIG. 4, a homogeneity score H(Bⱼ) may be determined for each branch by calculating the mean value of the homogeneity scores of each cluster in the branch. These scores are illustrated in Table 1.

Operation 330 may include selecting a branch level based on the homogeneity scores. For example, branch level 4 of the set of clusters shown in FIG. 4 may be selected because it is the first level to include only homogenous clusters, as shown in Table 1 (H(B₄)=1). However, other branch levels may be selected by adjusting a threshold branch level homogeneity.

For example, a threshold branch level homogeneity may be 90%. In these instances, branch level 3, which contains a total of four clusters and has a branch level homogeneity score of 92% (Table 1). Branch level 3 contains fewer clusters than branch level 4. Therefore, selecting branch level 3 instead of branch level 4 may reduce the amount of computing power needed to calculate explanations for the clustered transactions. In some embodiments, the threshold branch level homogeneity may be adjusted to optimize the accuracy of explainability versus available computing resources

Explanation scores may be generated for each cluster in a “homogenous” region (e.g., branch level selected at operation 330). This is illustrated at operation 340. An explanation score for a cluster is referred to herein as a “unified” explanation score and is based on explanation scores of transactions in the cluster. Transaction explanation scores and unified explanation scores may be generated by explainability component 236 (e.g., using SHAP, LIME with aggregation, etc.) for clusters selected at operation 330. The labeled transactions 210 in the selected clusters may be associated with previously calculated explanation scores, but explanation scores may also be calculated for one or more transactions at operation 340.

In some embodiments, a unified explanation for a selected cluster may be generated by calculating the centroid of the cluster, followed by an explainability score for the centroid. In further embodiments, a unified explanation may be generated for a cluster by calculating explainability scores for a sample of transactions within the cluster and then summarizing the explainability scores in a mean vector. However, any appropriate techniques for determining cluster explainabilities may be used.

Parameters of the explainability calculations (e.g., type of calculation, number of transactions sampled, etc.) may be selected based on factors such as the number of clusters and/or transactions, desired level of accuracy, available computing resources, etc. Explainability parameters may be set/adjusted by a user or automatically. The unified explanations may be stored in precomputed explanations 260 (FIG. 2). The precomputed explanations 260 may be updated with new explanations generated by additional iterations of process 300 and/or other retraining/fine-tuning operations. This is discussed in greater detail below with respect to FIG. 5.

FIG. 5 is a flowchart illustrating a process 500 of determining explainability of live transactions, according to some embodiments. Process 500 may be performed by components of environment 200 and, for illustrative purposes, is discussed with reference to FIG. 2. A live transaction 215 may be received. This is illustrated at operation 510. The live transaction 215 may be received in real-time and may be an unlabeled or labeled transaction. In some embodiments, AI module 220 receives the live transaction 215 at or before operation 510 and generates predictions or other outputs corresponding to input features of the live transaction 215.

Input features are extracted from the live transaction 215. This is illustrated at operation 515. The input features may be represented by input fields in an input space vector. This is discussed in greater detail with respect to FIG. 2. In some embodiments, the input features are extracted by AI module 220 or input analyzer 233. The input analyzer 233 can receive the input vector and determine an input space cluster (e.g., generated at operation 310 illustrated in FIG. 3) that is closest to the input features of the live transaction 215. This is illustrated at operation 520.

The closest cluster is also referred to herein as the cluster “most aligned” with the input vector of the live transaction 215. The most aligned cluster may be located using clustering techniques such as those discussed above. For example, hierarchical clustering techniques may be used to align the input vector of the live transaction 215 with the input space clusters generated at operation 310.

Input analyzer 233 may then determine whether the most aligned cluster satisfies a “closeness threshold”. This is illustrated at operation 530. For example, the closeness threshold may be a threshold distance between the most aligned cluster and the input vector of the live transaction 215.

If the most aligned cluster does not satisfy the closeness threshold (NO at operation 530), an explanation score may be generated for an outcome/prediction of the live transaction 215. This is illustrated at operation 540. The live transaction data and new explainability score may be stored and/or provided to a user (not shown). Process 500 may then proceed to operation 565 (see below) or end after generating the new explanation score.

If the most aligned cluster does satisfy the closeness threshold (YES at operation 530), it can be determined whether a transaction in the most aligned cluster has an output label matching that of the completed live transaction 215. This is illustrated at operation 550. An output label of a clustered transaction that matches an output label of a live transaction 215 is referred to herein as a “congruent label”. If a congruent label is found (YES at operation 550), a unified explanation mapped to the most aligned cluster can be used as an explanation for the live transaction 215. This is illustrated at operation 560. However, if no congruent label is found (NO at operation 550), a new explanation score may be generated for the outcome/prediction of the live transaction 215 at operation 540.

Labeled transactions 210 may be updated to include the input features of the live transaction 215 and corresponding transaction output labels (outcomes/predictions generated by AI module 220). This is illustrated at operation 565. However, in other embodiments, process 500 may end or proceed to operation 570 after selecting a precomputed explanation at operation 560.

At operation 570, the generated new explanation (operation 540) or selected precomputed explanation (operation 560) may optionally be used to generate a recommendation. Operation 570 may include generating a report that includes an explanation score. For example, explainability component 236 may generate one or more reports and/or provide (e.g., over a computer network) a user interface to a client device, such that the user can view the explanation scores and/or other related information and metrics. In some embodiments, the report generator may generate explanation reports persistently, at intervals, upon user request, etc. In some embodiments, data representing the reports is stored on one or more servers associated with computing environment 100 illustrated in FIG. 1. The reports may be transmitted to user device(s), e.g., in messages, in response to an associated application and/or a user interface being accessed on the user device, in response to a user request, etc. In some embodiments, a notification is generated when the user device receives a report, such as a push notification, an in-application notification, an email, etc. The reports may include one or more visual representations (e.g., charts, graphs, tables, etc.) of the explanations and/or related insights.

Retraining (not shown) may occur in response to a user request, at given intervals, persistently, or in response to a recommendation generated at operation 570. For example, the recommendation may prompt retraining of a deployed model (e.g., AI module 220) in response to determining that training data classifications have been over-fitted. In some embodiments, recommendations are provided to users (e.g., in an explanation report) who can decide whether to implement the recommendations. In further embodiments, the retraining may be carried out automatically. In some embodiments, retraining may include additional iterations of process 300 using the updated labeled transactions 210 (operation 310).

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the present disclosure.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof.

In the previous detailed description of example embodiments of the various embodiments, reference was made to the accompanying drawings (where like numbers represent like elements), which form a part hereof, and in which is shown by way of illustration specific example embodiments in which the various embodiments may be practiced. These embodiments were described in sufficient detail to enable those skilled in the art to practice the embodiments, but other embodiments may be used and logical, mechanical, electrical, and other changes may be made without departing from the scope of the various embodiments. In the previous description, numerous specific details were set forth to provide a thorough understanding the various embodiments. However, the various embodiments may be practiced without these specific details. In other instances, well-known circuits, structures, and techniques have not been shown in detail in order not to obscure embodiments.

When different reference numbers comprise a common number followed by differing letters (e.g., 100a, 100b, 100c) or punctuation followed by differing numbers (e.g., 100-1, 100-2, or 100.1, 100.2), use of the reference character only without the letter or following numbers (e.g., 100) may refer to the group of elements as a whole, any subset of the group, or an example specimen of the group.

As used herein, “a number of” when used with reference to items, means one or more items. For example, “a number of different types of networks” is one or more different types of networks.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, and item C” may include item A, item A and item B, or item B. This example also may include item A, item B, and item C or item B and item C. Of course, any combinations of these items can be present. In some illustrative examples, “at least one of” can be, for example, without limitation, two of item A; one of item B; ten of item C; four of item B and seven of item C; or other suitable combinations.

What is claimed is:

1. A method, comprising:
obtaining, by a processor communicatively coupled to a memory, a set of labeled transactions comprising input features and corresponding output labels generated by a machine learning (ML) model; and
generating, by the processor, an explainable artificial intelligence (XAI) module, wherein the generating comprises:
clustering the labeled transactions based on the input features;
scoring homogeneity of the clustered transactions based on the corresponding output labels;
selecting at least one cluster from the clustered transactions based on the homogeneity scoring;
obtaining, by an explainability model, explainability scores for transactions in the at least one cluster;
generating a unified explainability score for the at least one cluster based on the explainability scores; and
storing the unified explainability score in a set of precomputed explanations.

2. The method of claim 1, further comprising receiving a live transaction from a user device.

3. The method of claim 2, further comprising selecting, by the XAI module, an explainability score for the live transaction from the set of precomputed explanations.

4. The method of claim 3, wherein the explainability score is selected based on input features of the live transaction.

5. The method of claim 2, further comprising:
selecting, by the XAI module, a most aligned cluster from the at least one cluster based on input features of the live transaction; and
determining, by the XAI module, whether the most aligned cluster satisfies a closeness criterion.

6. The method of claim 5, further comprising, in response to determining that the most aligned cluster does not satisfy the closeness criterion, generating a new explainability score for the live transaction.

7. The method of claim 5, further comprising, in response to determining that the most aligned cluster satisfies the closeness criterion, comparing output labels of the most aligned cluster with output labels of the live transaction.

8. The method of claim 7, further comprising:
determining, based on the comparing, that the output labels do not include a congruent output label; and
in response to the determining that the output labels do not include a congruent output label, generating a new explainability score for the live transaction.

9. The method of claim 7, further comprising:
identifying a congruent output label based on the comparing; and
in response to the identifying the congruent output label, selecting an explainability score for the live transaction from the set of precomputed explanations.

10. The method of claim 9, wherein the selected explainability score is a unified explainability score for the most aligned cluster.

11. The method of claim 10, further comprising updating the most aligned cluster to include the input features of the live transaction.

12. The method of claim 1, wherein the set of labelled transactions comprises transactions implemented by a database management system.

13. The method of claim 1, wherein:
the clustering comprises forming branch levels of the clustered transaction by hierarchical clustering;
the homogeneity scoring comprises generating homogeneity scores for the branch levels; and
the selecting the at least one cluster comprises selecting a branch level based on the homogeneity scoring.

14. The method of claim 1, wherein the selecting the at least one cluster comprises selecting a cluster having a homogeneity score above an adjustable threshold homogeneity score.

15. A system, comprising:
a memory; and
a processor communicatively coupled to the memory, wherein the processor is configured to perform a method comprising:
obtaining, by a processor communicatively coupled to a memory, a set of labeled transactions comprising input features and corresponding output labels generated by a machine learning (ML) model; and
generating, by the processor, an explainable artificial intelligence (XAI) module,
wherein the generating comprises:
clustering the labeled transactions based on the input features;
scoring homogeneity of the clustered transactions based on the corresponding output labels;
selecting at least one cluster from the clustered transactions based on the homogeneity scoring;
obtaining, by an explainability model, explainability scores for transactions in the at least one cluster;
generating a unified explainability score for the at least one cluster based on the explainability scores; and
storing the unified explainability score in a set of precomputed explanations.

16. The system of claim 15, further comprising:
receiving a live transaction from a user device; and
selecting, by the XAI module, an explainability score for the live transaction from the set of precomputed explanations.

17. The system of claim 16, wherein the explainability score is selected based on input features of the live transaction.

18. A computer program product, the computer program product comprising a computer readable storage medium having program instructions embodied therewith, the program instructions executable by a processor to cause a device to perform a method, the method comprising:
obtaining, by a processor communicatively coupled to a memory, a set of labeled transactions comprising input features and corresponding output labels generated by a machine learning (ML) model; and
generating, by the processor, an explainable artificial intelligence (XAI) module, wherein the generating comprises:
clustering the labeled transactions based on the input features;
scoring homogeneity of the clustered transactions based on the corresponding output labels;
selecting at least one cluster from the clustered transactions based on the homogeneity scoring;
obtaining, by an explainability model, explainability scores for transactions in the at least one cluster;
generating a unified explainability score for the at least one cluster based on the explainability scores; and
storing the unified explainability score in a set of precomputed explanations.

19. The computer program product of claim 18, further comprising:
receiving a live transaction from a user device; and
selecting, by the XAI module, an explainability score for the live transaction from the set of precomputed explanations.

20. The computer program product of claim 19, wherein the explainability score is selected based on input features of the live transaction.
